(19) United States
(12) Patent Application Publication
(10) Pub. No.: US 2014/0313642 A1
(43) Pub. Date: Oct. 23, 2014

(54) POWER STACK STRUCTURE AND METHOD

(71) Applicant: GENRERAL ELECTRIC COMPANY, Schenectady, NY (US)

(72) Inventors: Fan Zhang, Shanghai (CN); Junfeng Sheng, ShenZhen (CN); Xiaodan Zhang, Shanghai (CN); Richard S. Zhang, Shanghai (CN)

(21) Appl. No.: 14/355,748

(22) PCT Filed: Nov. 4, 2011
(86) PCT No.: PCT/CN2011/081830

§ 371 Date: May 1, 2014

(51) Int. Cl. H02M 7/00; H02B 1/56; H02B 1/20

(52) U.S. Cl. CPC H02M 7/003; H02B 1/205; H02B 1/56
USPC 361/637; 29/25.01

(57) ABSTRACT

A power conversion apparatus includes plural press-pack power semiconductor devices; plural thermal and electric conducting blocks provided among the plural press-pack power semiconductor devices; and plural bus bars provided among the plural press-pack power semiconductor devices and the plural thermal and electric conducting blocks to form a first column that is clamped under a predetermined mechanical force. The plural bus bars are directly pressed in the first or more columns for electrical connection, at least one of the press-pack power semiconductor devices is sandwiched between two thermal and electrical conducting blocks, and at least one of the bus bars is sandwiched between two thermal and electric conducting blocks. A method for assembling the power conversion apparatus is also provided. The apparatus and the method can provide optimum heat transfer for press-pack power semiconductor devices and minimum commutation loss and stress.

### BACKGROUND

1. Technical Field

Embodiments of the subject matter disclosed herein generally relate to methods and systems and, more particularly, to the electrical and mechanical structure of a power stack assembly.

2. Discussion of the Background

Press-pack semiconductor devices are in many applications powerful components that are used for controlling a flow of electrical power or converting voltage, current or frequency necessary for connecting to a motor or a generator, or interfacing with a utility grid. The press-pack semiconductor devices are used in power conversion apparatuses (e.g., power converters) for a diverse range of applications. Those applications include motor drives for oil and gas, metal, water, mining and marine industries, as well as power/frequency converters for renewable energy (wind, solar), and electric power industries. To utilize the full potential of the press-pack semiconductor devices, a proper mechanical design of the complete assembly, including the press-pack semiconductor devices, heat sinks, bus bars and other components, is required.

The current and heat conducting interfaces of a press-pack semiconductor device are designed to retain good conduction properties throughout the equipment lifetime. This is accomplished by creating a sufficient number of stable metal-to-metal connections which can efficiently conduct current from the semiconductor device to the bus bar.

For power converters with press-pack power semiconductor devices, the power semiconductor devices are stacked on top of each other under a required pressure to make electrical and thermal contacts to form an electrical circuit and to remove heat generated from losses during operation. The stack (power stack assembly) may have single or plural of columns comprising power semiconductor devices, heat sinks, insulators, bus bars and alike with a clamping mechanism to hold those components together. Pressure is applied to each column to assure proper electrical and thermal contact between the individual press pack modules. The press-pack semiconductor devices are the core components in a power converter or variable frequency drive for electric motors.

The power semiconductor devices may include Integrated Gate Commutated Thyristor (IGCT), Insulated Gate Bipolar Transistor (IGBT), Injection-Enhanced Gate Transistor (IEGT), Thyristor (ETT or LTT), and diode modules. For high power medium voltage power converters, when used in applications such as oil and gas, electric power, steel mill, and offshore, the press-pack form is preferred due to its higher power density and higher power handling capability. Even more, the press-pack form is preferred for the ruggedness and benign failure condition of the press-pack semiconductor devices, i.e., due to strong mechanical clamping force, failure of press-pack components will not lead to an arc and plasma event, unlike a power semiconductor module in a plastic package.

An example of a power stack assembly 10 is shown in FIG. 1A. FIG. 1A shows a clamping mechanism 12 and 14 that maintains under pressure plural press-pack power semiconductor devices 16, bus bars 18, and heat sinks 20. The press-pack power semiconductor devices 16 are directly connected to the bus bars 18 while the heat sinks 20 directly contact the bus bars 18.

However, this arrangement increases the thermal impedance from the press-pack power semiconductor device to the heat sink because a surface of the bus bar is not as flat (smooth) as the surface of the press-pack power semiconductor device. In this regard, it is noted that a face (pole face) of the heat sinks 20 and the press-pack power semiconductor devices 16 are manufactured with a high degree of flatness while the commercially available bus bars 18 may include multiple sheets of copper laminated together. Thus, the flatness of the bus bar is typically lower than that of the heat sink or the press-pack power semiconductor device. This flatness difference between the press-pack power semiconductor device and the bus bar determines an imperfect contact between these two elements, which degrades the capability of the entire power stack assembly by increasing the thermal resistance, which is undesirable.

A different approach that overcomes some of the limitations discussed above proposes to mount a bus bar 22 on a side of a heat sink 20 as shown in FIG. 1B. However, this approach tends to increase a stray inductance in the electrical circuit due to the increased distance between columns, which adds more electrical stress to the power switches and increase the power losses besides adding more parts and labor hours to the power stack assembling.

Accordingly, it would be desirable to provide systems and methods that avoid the afore-described problems and drawbacks.

### SUMMARY

According to one exemplary embodiment, there is a power conversion apparatus that includes plural press-pack power semiconductor devices; plural thermal and electric conducting blocks provided among the plural press-pack power semiconductor devices; and plural bus bars provided among the plural press-pack power semiconductor devices and the plural thermal and electric conducting blocks to form a first column that is clamped under a predetermined mechanical force. The plural bus bars are directly pressed in the one or more columns for electrical connections, at least one press-pack power semiconductor device is sandwiched between two thermal and electrical conducting blocks, and at least one bus bar is sandwiched between two thermal and electric conducting blocks.

According to another exemplary embodiment, there is a power conversion apparatus that includes plural press-pack power semiconductor devices; plural thermal and electric conducting blocks provided among the plural press-pack power semiconductor devices; plural bus bars provided among the plural press-pack power semiconductor devices and the plural thermal and electric conducting blocks to form a first column that is clamped under a predetermined mechanical force; first and second insulators configured to sandwich the plural press-pack power semiconductor devices, the thermal and electric conducting blocks, and the plural bus bars to form a first column so that ends of the first column are electrically insulated; and a stack frame configured to apply a predetermined rated force to the first and second insulators and the first column. The plural bus bars are directly pressed in the first column for electrical connections, at least one press-pack power semiconductor device is sandwiched between two thermal and electrical conducting blocks, and at least one bus bar is sandwiched between two thermal and electric conducting blocks.

According to still another exemplary embodiment, there is a method for assembling a power conversion apparatus that provides optimum heat transfer for press-pack power semiconductor devices and minimum commutation loss and stress. The method includes a step of sandwiching press-pack power semiconductor devices between corresponding thermal and electric conducting blocks to form a first column; a step of inserting bus bars into the first column so that at least one bus bar is provided between two thermal and electric conducting blocks; a step of adding first and second insulators to ends of the first column so that the ends of the first column are electrically insulated; and a step of applying a rated force on the first column.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A-B are schematic diagrams of conventional power stack assemblies;

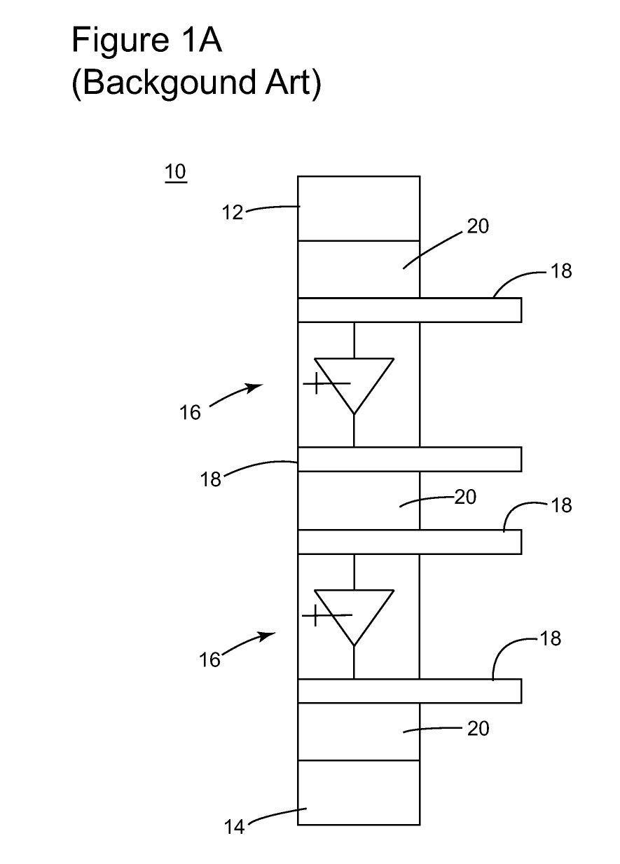

FIG. 2 is a schematic diagram of a power stack assembly according to an exemplary embodiment;

FIG. 3 is a schematic diagram of another power stack assembly according to an exemplary embodiment;

FIG. 4 is a schematic diagram illustrating a flatness of a surface according to an exemplary embodiment;

FIG. 5 is a schematic diagram of a delta connected power stack assembly according to an exemplary embodiment;

FIG. 6 is a schematic diagram of a straight line connected power stack assembly according to an exemplary embodiment; and

FIG. 7 is a flow chart illustrating a method for assembling a power stack assembly in a power conversion apparatus according to an exemplary embodiment.

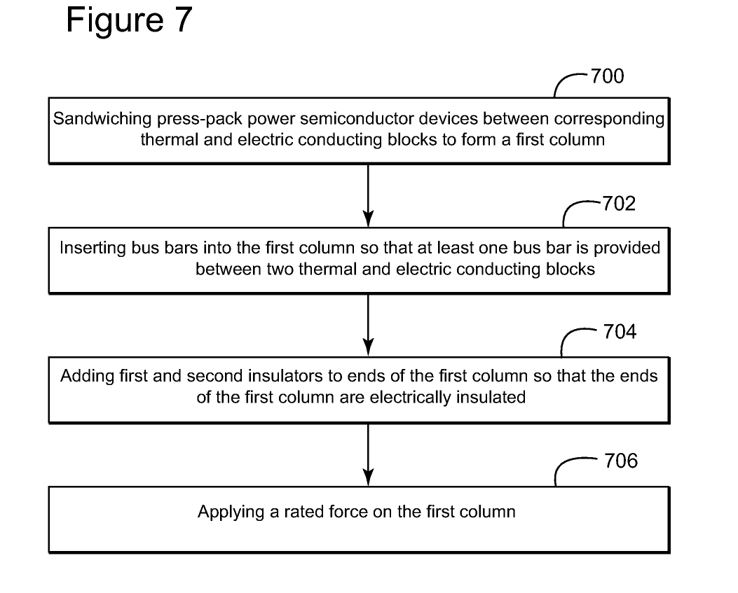

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of press-packed semiconductor devices stacked in a power stack assembly of a power conversion apparatus. However, the embodiments to be discussed next are not limited to these apparatuses.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, a power conversion apparatus includes plural press-pack power semiconductor devices, plural heat sinks, and at least one bus bar that form at least a column. The bus bar is provided between adjacent heat sinks so that a direct contact between the bus bar and the press-pack power semiconductor devices is avoided. In another exemplary embodiment, the bus bar is distributed between a heat sink and a metal block so that direct contact between the bus bar and the press-pack power semiconductor devices is avoided. The metal block may be in direct contact with the press-pack semiconductor device. A surface of the heat sink or of the metal block that directly faces the press-pack semiconductor devices may be manufactured to have a higher flatness than a face of the bus bar, thus reducing the thermal impedance. Also, for an arrangement in which more than one columns are formed, a thermal conduction path between the press-pack semiconductor device and a corresponding heat sink is minimized and electrical stresses are decreased due to the reduced commutation loop.

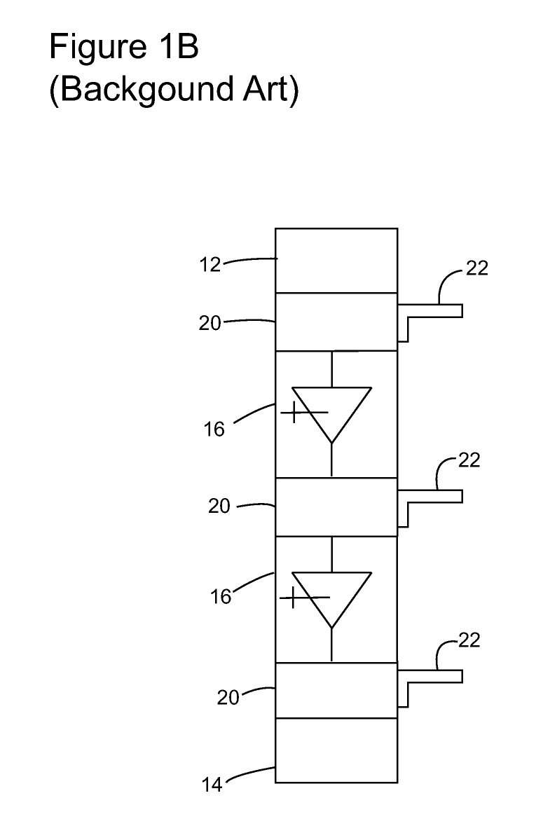

In an exemplary embodiment illustrated in FIG. 2, a power stack assembly 40 has one column that includes plural press-pack power semiconductor devices 42. At least one press-pack power semiconductor device is sandwiched between two heat sinks 44. In one application, each press-pack power semiconductor device is sandwiched between two heat sinks 44. The press-pack power semiconductor devices 42 may have a control gate 45. Bus bars 46 are placed to be in direct contact with corresponding heat sinks 44 and not with the press-pack semiconductor devices 42. In one exemplary embodiment, no bus bar 46 is in direct contact with a press-pack power semiconductor device 42.

An example of a press-pack power semiconductor device 42 is an integrated gate-commutated thyristor (IGCT), an IGBT, or an IEGT. Another example of a press-pack power semiconductor device is a diode

An IGCT or IEGT or press-pack IGBT device in a power stack assembly needs to be pressed with a large force in order to function efficiently from an electrical and thermal point of view. One condition for achieving this efficiency is a uniform distributed force on a face (pole face) of the press-pack power semiconductor device that faces and contacts the heat sinks 44. A smooth and flat pole face ensures uniform force distribution, good electrical contact and good thermal transfer. Accordingly, the heat sinks need to have adequate mechanical robustness to withstand compression with high forces without deformation, e.g., up to 135 kN. Deformation could lead to inhomogeneous force distribution. Cast or extruded heat sinks may be used. The heat sinks may also be made of Al or Cu. Other materials may be used. The heat sinks may be machined properly through processes such as milling or fine turning to get to the recommended surface finish.

Not the same may be achieved for the bus bars 46. As the bus bars 46 are commercially available, these bus bars are made of sheets of copper or other material pressed together. However, such a process cannot achieve a flatness comparable to that of the press-pack power semiconductor devices or the heat sinks. For this reason, according to this exemplary embodiment, the press-pack power semiconductor devices 42 are sandwiched between the heat sinks 44 instead of the bus bars 46. Thus, the heat sinks decouple the negative effect induced by the bus bar when inserted in the column of the press-packed semiconductor devices.

A stack frame 47 that includes first and second end plates 48a may be used to clamp together the press-pack power semiconductor devices, heat sinks and bus bars. The stack frame may be any of those known in the art. For example, the stack frame 47 may include rods 48b for maintaining the elements of the column compressed with a desired force that is recommended for a good operation of the press-pack power semiconductor devices. A force application mechanism 48c may be used to apply the desired force. Insulators 49 may be provided to sandwich the entire column of the power stack assembly 40 for preventing unwanted electrical contacts. The stack frame is configured to directly act on the insulators 49.

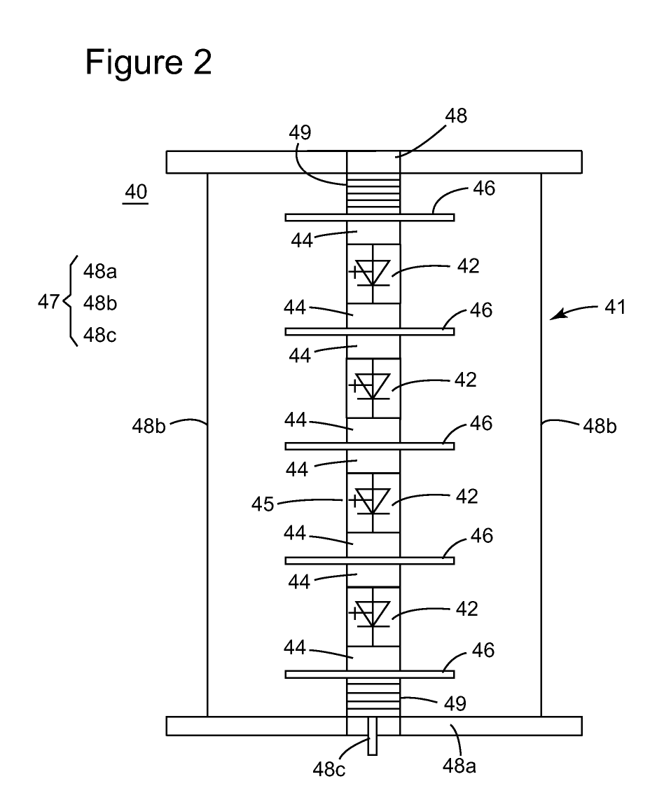

According to another exemplary embodiment illustrated in FIG. 3, a column in a power stack assembly 50 may include press-pack power semiconductor devices 52 that are sandwiched by heat sinks 54 or by a heat sink 54 and a metal block 56. In this exemplary embodiment, at least one bus bar 58 is not in direct contact with the press-pack power semiconductor devices. However, in another exemplary embodiment, each bus bar is not in direct contact with the press-pack power semiconductor devices. A metal block 56 is preferred to the bus bar 58 as a face of the metal block 56 facing the press-pack power semiconductor device may be manufactured to have a flatness comparable with that of the press-pack power semiconductor device. Although these metal blocks introduce a larger thermal impedance compared with the heat sinks, they are a low cost alternative to heat sinks if they provide adequate thermal performance.

FIG. 3 shows that the entire column of press-pack power semiconductor devices, heat sinks and bus bars is sandwiched by insulating elements 60 and clamped by a clamping mechanism that includes first and second ends 62 and 64. Each press-pack power semiconductor device 52 may be electrically controlled via a corresponding gate 64.

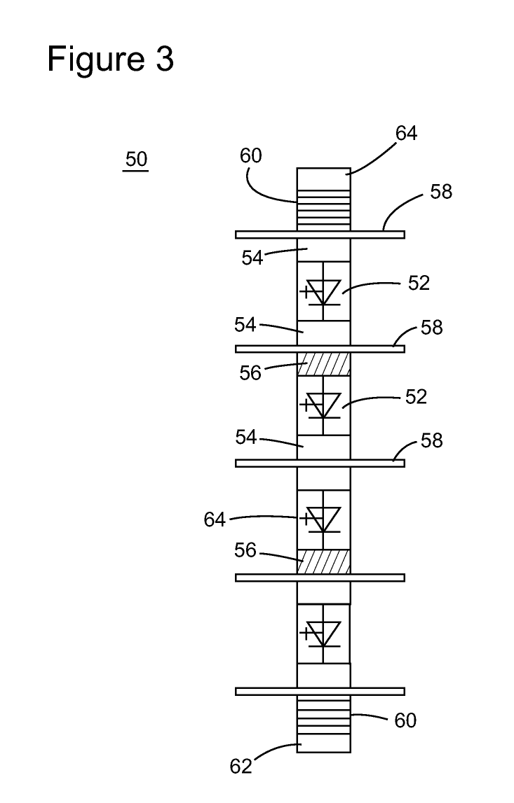

In one exemplary embodiment, a flatness of the pole face of the press-pack power semiconductor devices and the heat sinks and/or metal blocks directly contacting the press-pack power semiconductor devices is 15 μm or less. The flatness is defined as shown in FIG. 4. A specific pole face A is limited by two parallel planes B and C at a maximum distance of 15 μm apart. To achieve this flatness, the heat sink and the metal block may be made of a block of aluminum, copper or other metal while the bus bar, which has a poorer flatness, is made of laminated sheets of copper.

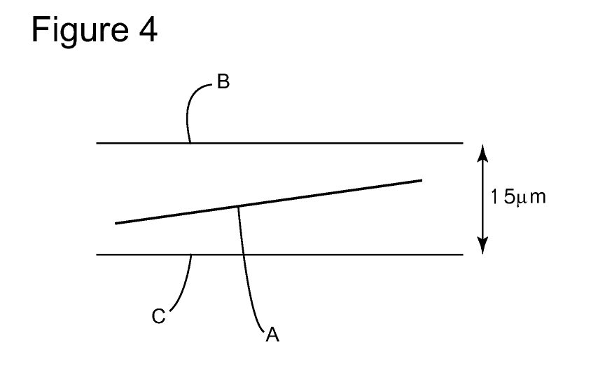

FIG. 5 illustrates an embodiment in which a three-column IGCT power stack assembly 80 has three columns 82, 84, and 86 connected in delta to each other. A frame that maintains the columns in place and under a predetermined force is not shown as it is known in the art. For example, such a frame is shown in FIG. 2. The power stack assembly 80 includes press-pack power semiconductor devices (IGCT) 88 having a corresponding gate 90. The press-pack power semiconductor device 88 is sandwiched by two heat sinks 92. However, the columns may include diodes 94 as the press-pack power semiconductor devices and the diodes 94 are sandwiched between a heat sink 92 and a metal block 96. Bus bars 100 are inserted in each column to directly contact the heat sinks 92 or the metal blocks 96 but not the press-pack power semiconductor devices 88.

In one exemplary embodiment, some bus bars may be inserted into the columns to directly contact the press-pack power semiconductor devices. Insulators 102 may be used to electrically insulate each column from unwanted contacts at its respective ends. As shown in FIG. 5, a same bus bar 104 (collective bus bar) may extend to all three columns 82, 84, and 86. In other words, a single piece bus bar 104 may electrically connect various elements in the three columns 82, 84, and 86. The single piece bus bar 104 may have flexible parts 106 for ensuring that the various parts that are inserted in the columns may slightly move one relative to the other. The flexible parts 106 may be formed between the columns 82, 84 and 86. The single piece bus bar is made of a single piece of metal that forms a closed loop to minimize a commutation inductance.

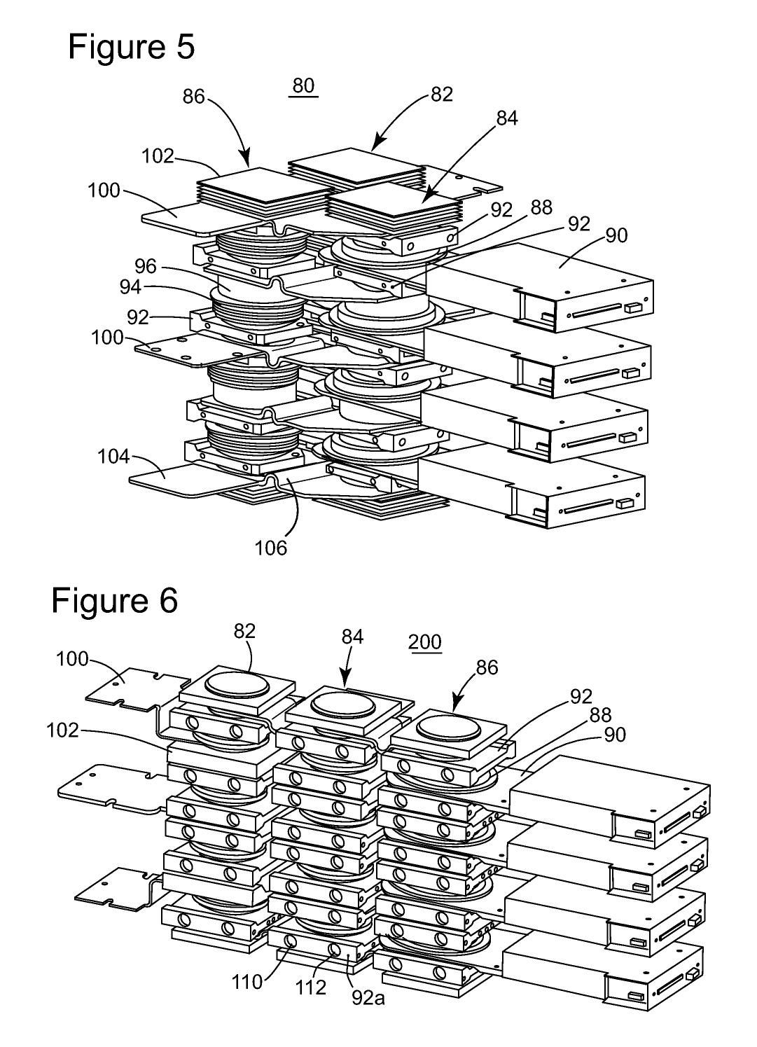

FIG. 6 shows another power stack assembly 200 having columns 82, 84 and 86 provided in-line. This embodiment shows that various insulators 102 may be inserted into the columns. FIG. 6 also shows that a heat sink 92a may have one inlet 110 and one outlet 112. A cooling piping system (not shown) may be connected to the inlet 110 for pumping a cooling fluid inside the heat sink 92a and after a heat transfer occurs between the fluid inside the heat sink 92a, the hot cooling fluid leaves the heat sink at outlet 112. In this way, the heat sink 92a is cooled in a forced way to achieve a lower temperature of the press-packed power semiconductor device 88. While FIG. 6 shows a heat sink configured to cool a press-pack semiconductor device, it is noted that other elements of the power stack assembly, e.g., a resistor or inductor, may have a cooling channel built into the element.

The novel structures discussed above advantageously provides no pole face of the press-packed semiconductor devices in contact with the bus bars, improves electrical and thermal performance, uses no screws for attaching the bus bars to the columns, reduces distances between columns, and reduces stray inductances. In addition, these novel structures require less labor hours for assembly and disassembly.

According to an exemplary embodiment, there is a method for assembling a power stack assembly that includes press-packed semiconductor devices. The method includes a step 700 of sandwiching press-pack power semiconductor devices (42) between corresponding thermal and electric conducting blocks (44) to form a first column; a step 702 of inserting bus bars (46) into the first column so that at least one bus bar is provided between two thermal and electric conducting blocks (44); a step 704 of adding first and second insulators (60) to ends of the first column so that the ends of the first column are electrically insulated; and a step 706 of applying a rated force on the first column.

The disclosed exemplary embodiments provide a system and a method for a power stack assembly having press-packed power semiconductor devices to improve electrical and thermal properties of the power stack assembly. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A power conversion apparatus, comprising:
plural press-pack power semiconductor devices;
plural thermal and electric conducting blocks among the plural press-pack power semiconductor devices; and
plural bus bars among the plural press-pack power semiconductor devices and the plural thermal and electric conducting blocks to form at least one column comprising a first column clamped under a predetermined mechanical force,
wherein:
the plural bus bars are directly pressed in the at least one column for electrical connections,
at least one of the plural press-pack power semiconductor devices is sandwiched between two of the plural thermal and electric conducting blocks, and
at least one of the plural bus bars is sandwiched between two of the plural thermal and electric conducting blocks.

2. The power conversion apparatus of claim 1, wherein at least one of the plural thermal and electric conducting block blocks is a heat sink.

3. The power conversion apparatus of claim 2, wherein the heat sink is a liquid cooled heat sink or an air cooled heat sink.

4. The power conversion apparatus of claim 1, wherein at least one of the plural thermal and electric conducting blocks is a metal block.

5. The power conversion apparatus of claim 1, wherein the predetermined mechanical force is different or the same for various columns of the at least one column.

6. The power conversion apparatus of claim 1, wherein the plural bus bars comprise laminated sheets of metal.

7. The power conversion apparatus of claim 1, wherein at least one of the plural press-pack power semiconductor devices is one of IGCT, press-pack IGBT, press-pack IEGT, diode or thyristor.

8. The power conversion apparatus of claim 1, further comprising:
a first insulator and a second insulator, wherein the first and the second insulators are configured to sandwiched the first column so that ends of the first column are electrically insulated.

9. The power conversion apparatus of claim 8, further comprising:
a stack frame configured to apply the predetermined mechanical force to the first and the second insulators, and the first column.

10. The power conversion apparatus of claim 1, further comprising:
a second column and a third column, wherein each of the second column and the third column comprises:
plural press-pack power semiconductor devices;
plural thermal and electric conducting blocks; and
plural bus bars, wherein each of the plural bus bars is sandwiched between two of the corresponding plural thermal and electric conducting blocks,
wherein the first, the second and the third columns are in a straight line.

11. The power conversion apparatus of claim 10, further comprising:
a straight line collective bus bar configured to connect the first, the second, and the third columns, wherein the straight line collective bus bar is sandwiched between corresponding thermal and electric conducting blocks of the first, the second, and the third columns.

12. The power conversion apparatus of claim 1, further comprising:
a second column and a third column, wherein each of the second column and the third column comprises:
plural press-pack power semiconductor devices;
plural thermal and electric conducting blocks; and
plural bus bars, wherein each of the plural bus bars is sandwiched between two of the corresponding plural thermal and electric conducting blocks,
wherein the first, the second, and the third columns are in a delta configuration.

13. The power conversion apparatus of claim 12, further comprising:
a ring-shaped collective bus bar configured to connect the first, the second, and the third columns, wherein the ring-shaped collective bus bar is sandwiched between corresponding thermal and electric conducting blocks of the first, the second, and the third columns.

14. A power conversion apparatus comprising:
plural press-pack power semiconductor devices;
plural thermal and electric conducting blocks among the plural press-pack power semiconductor devices;
plural bus bars among the plural press-pack power semiconductor devices and the plural thermal and electric conducting blocks to form a first column clamped under a predetermined mechanical force;
a first insulator and a second insulator, wherein the first and the second insulators are configured to sandwich the plural press-pack power semiconductor devices, the thermal and electric conducting blocks, and the plural bus bars to form the first column so that ends of the first column are electrically insulated; and
a stack frame configured to apply a predetermined rated force to the first and the second insulators, and the first column,
wherein:
the plural bus bars are directly pressed in the first column for electrical connections,
at least one of the plural press-pack power semiconductor devices is sandwiched between two of the plural thermal and electric conducting blocks, and
at least one of the plural bus bars is sandwiched between two of the plural thermal and electric conducting blocks.

15. A method for assembling a power conversion apparatus, the method comprising:
sandwiching press-pack power semiconductor devices between corresponding thermal and electric conducting blocks to form a first column;
inserting bus bars into the first column so that at least one of the bus bars is between two of the corresponding thermal and electric conducting blocks;
adding a first insulator and a second insulator to ends of the first column so that the ends of the first column are electrically insulated; and
applying a rated force on the first column.
